(19) United States
(12) Patent Application Publication
(10) Pub. No.: US 2020/0229396 A1
(43) Pub. Date: Jul. 23, 2020

(54) PET ENTERTAINMENT AND GROOMING SYSTEM AND METHOD OF USE

(71) Applicant: Renee Dewitt, Arlington, TX (US)

(72) Inventor: Renee Dewitt, Arlington, TX (US)

(21) Appl. No.: 16/746,748

(22) Filed: Jan. 17, 2020

Related U.S. Application Data
(60) Provisional application No. 62/793,411, filed on Jan. 17, 2019.

(51) Int. Cl. A01K 13/00; A46B 13/02; A46B 5/00

(52) U.S. Cl. CPC A01K 13/00; A46B 2200/1093; A46B 5/0037; A46B 13/023

(57) ABSTRACT

A pet entertainment and grooming system is a set of bristles, wires or similar prickly arrangements attached to a body and anchored to provide a cat or other animal the opportunity to scratch, brush or otherwise stimulate the skin or fur. The system could be attached to a wall, an article of furniture or some other hard location or it could remain free-floating and be moved about by the cat. The system could also be used by people.

### BACKGROUND

### 1. Field of the Invention

The present invention relates generally to a pet entertainment and grooming system and methods of use. More specifically, the invention is related to a system and method to a cat scratcher having bristles for a cat to claw or brush itself against.

### 2. Description of Related Art

Systems and methods for pet entertainment and grooming devices are well known in the art. There are many different types of pet entertainment devices on the market, including toys specific for cats, dogs, birds, etc. For example, there are many cat toys such as multi-level lounging apparatus, scratching posts, lasers, stuffed animals and many others. Cats generally have a biological need to keep their claws sharp by scratching furniture and other surfaces, as well as providing a form of exercise. Cats also have a biological need to groom, self-groom, and scratch. Oftentimes, cats use objects around them such as furniture, walls, and corners to accomplish those tasks. Other times, cats are motivated to scratch furniture as a way of declaring territory.

One of the problems commonly associated with the above process is the limited use. Many pet entertainment and grooming devices are easily destroyed, inconvenient to use, are cumbersome to move, or are not enjoyable for the pet. Especially in the case of cats, when they become bored with the toy they often revert to scratching and brushing against other objects in the home like couches, sofas, tables, walls, and corners. However, clawing of furniture and other household furnishings, rugs, and other surfaces is destructive behaviors, which may force a cat owner to incur substantial monetary damages.

Accordingly, although great strides have been made in the area of pet entertainment and grooming systems and other devices for the entertainment or care of animals, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of a pet entertainment and grooming system in accordance with a preferred embodiment of the present application; and

FIG. 2 is a front view of the system of FIG. 1 in use;

FIG. 3 is a front view of the system of FIG. 1 in use;

FIG. 4 is a front view of an alternative embodiment of the system of FIG. 1 in use;

FIGS. 5 and 6 are cross-sectional top views of alternative embodiments of the system of FIG. 1;

FIG. 7 is a front view of an alternative embodiment of the system of FIG. 1;

FIG. 8 is a top view of an alternative embodiment of the system of FIG. 1;

FIG. 9 is a front view of an alternative embodiment of the system of FIG. 1 in use;

FIG. 10 is a front view of an alternative embodiment of the system of FIG. 1 in use;

FIG. 11 is a side view of an alternative embodiment of the system of FIG. 1;

FIG. 12 is a side view of an alternative embodiment of the system of FIG. 11;

FIG. 13 is a flowchart of a method of providing self-grooming to an animal.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems and methods for pet entertainment and grooming. Specifically, the present invention provides means of enabling a cat to self-groom. Additionally, the invention prevents damage to furniture or other items a cat may scratch. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

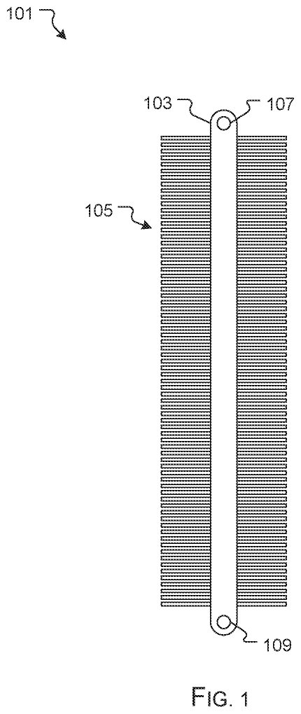

Referring now to the drawings wherein like reference characters identify corresponding or similar elements throughout the several views, FIG. 1 depicts a front view of a pet entertainment and grooming system in accordance with a preferred embodiment of the present application. It will be appreciated that system 101 overcomes one or more of the above-listed problems commonly associated with conventional systems and methods for pet entertainment and grooming.

In the contemplated embodiment, system 101 includes a body 103 having bristles 105 extending therefrom. The body also includes a first attachment device 107 and a second attachment device 109 configured to anchor or hold the system 101 during use or for storage. The bristles 105 are configured to be bendable and flexible which provides an animal with ample distraction. In addition, the bristles 105 further include a plurality of bristles for additional entertainment and grooming purposes.

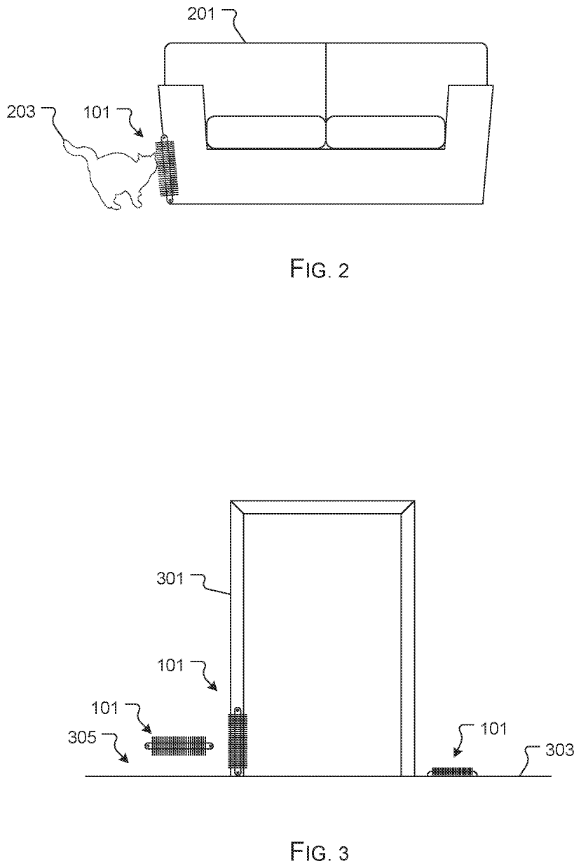

In use, as depicted by FIGS. 2 and 3, the system 101 is attached to an object such as a couch 201, door frame 301, floor 303, wall 305 clothing or other supporting structure. An animal such as a cat 203, is able to use the bristles 105 to scratch themselves while the body is held in place by the attachment devices 107 and 109.

It should be appreciated that one of the unique features believed characteristic of the present application is that the body 103 is attached to a support structure to enable the animal to self-groom while protecting the support structure from damage caused by the animal clawing or rubbing thereon.

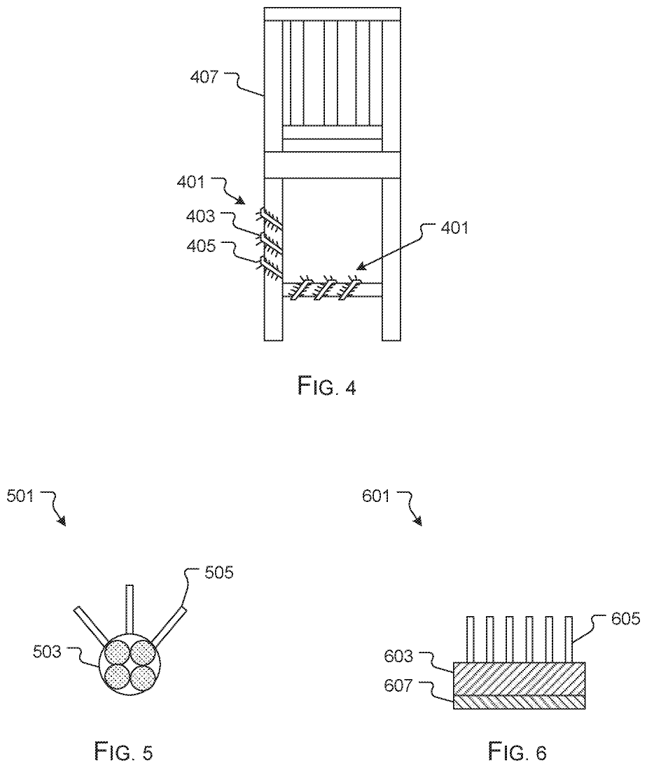

Referring now to FIG. 4, it is further contemplated that the body 103 could be of pliable material and that this embodiment 401 allows the body 403 to wrap about the support structure depicted here as a chair 407. This positions the bristles 405 all about the chair 407 and allows for greater access to and variety in scratching.

It is further contemplated, as depicted in FIGS. 5 and 6 that the configuration of the body will vary dependent on the intended use. For example, the body 503 could be of braided wire with the bristles 505 intertwined therein or the body 603 could be rigid and planer with the bristles 605 extending out. Additionally, an adhesive layer 607 is attached to the bottom of body 603 and is the attachment device of this embodiment 601. It will be appreciated and understood that in embodiment 501 the body 503 allows for manipulation thereof to create shapes or patterns.

While these configurations of the body have been depicted and described they are provided as examples and are not intended to limit the scope of the invention. Additionally, any method or means of attaching the body to the support structure is contemplated. For example, adhesive, magnetics, suction fasteners, hook and loop or clips all serve to anchor the body to the support structure. It is contemplated that the body itself could fulfill this function by bending or wrapping.

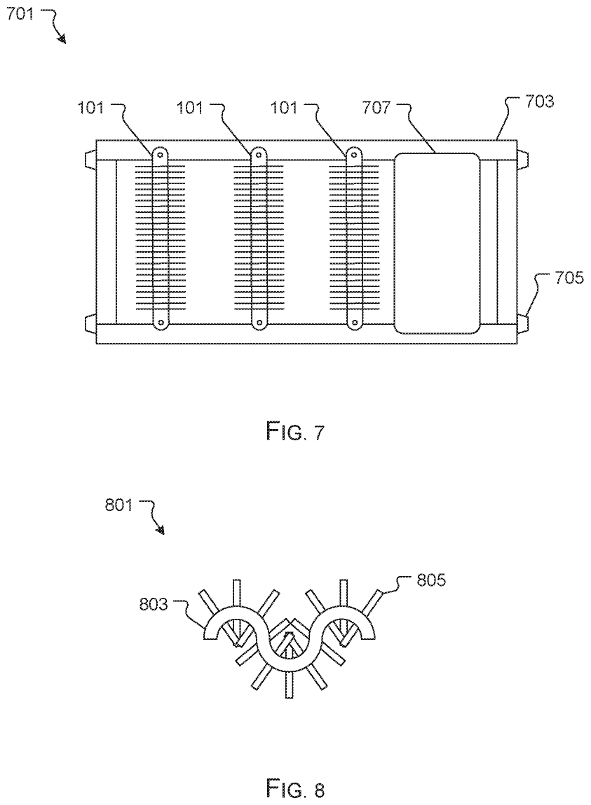

Referring now to FIG. 7 an alternative embodiment of the system 101 is depicted. Embodiment 701 includes a frame 703 as the support structure with a series of pet entertainment and grooming systems 101 attached thereto in addition to a clawing surface 707. A set of anchors 705 allow the frame to be positioned in a doorway or passageway to provide self-grooming, entertainment and movement restriction.

It is anticipated that the pet entertainment and grooming system of this gate system may include bristles or brushes, a clawing material or a combination thereof. The gate rails may comprise alternating pet entertainment and grooming system composed of a brush material, following by a pet entertainment and grooming system composed of a clawing material and so on. In an alternate embodiment, the gate railings may be replaced by a single sheet or multiple sheets of clawing material which may or may not have some border of brush material.

An embodiment 801 where no attachment devices are included is depicted by FIG. 8, where body 803 is twisted either permanent or temporary with the bristles 805 extending therefrom. It is contemplated that this embodiment 801 allows the animal to move the system about with them in play.

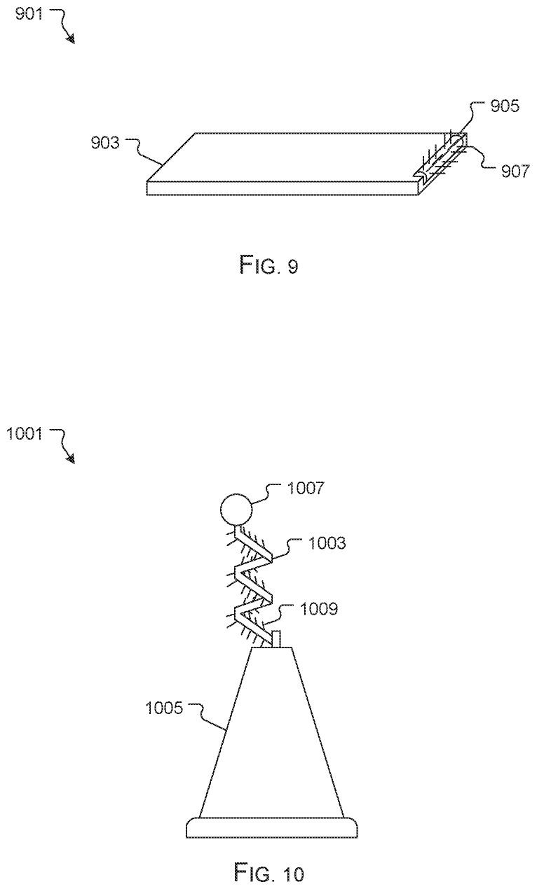

FIGS. 9 and 10 demonstrate additional methods of use of the system. Embodiment 901 has the body 907 attached to the edge of a mat 903 with the bristles 905 accessible from both the top and side thereof. Embodiment 1001 is attached to the top of a base 1005 so that the body 1003 stands erect with a toy 1007 such as catnip available along with bristles 1009 for the entertainment and grooming of the animal. It is contemplated that any toy could be included such as balls, streamers or the like.

The embodiment 901 could be shaped, 2D or 3D and may also include moveable parts put in motion by a motor that has a portable or fixed power source. The shaped cat scratchers may also be configured to travel on a moveable track or railing such that move like a train.

The present invention may take on several embodiments including but not limited to: wrappable brushes or clawing material, a mounted brush or clawing material, a stationary or mounted gate having 1,2, or 3D cat scratchers configured as the gate rails, mats, rugs, flooring or flat or cornered, wall attachments, or a cat mat playground comprising at least one cat scratcher as described herein. The cat mat playground may comprise the wrappable brushes, stationary brushes, or cat scratchers configured as animal shapes. The cat mat playground may be mounted on a vertical surface or placed on a horizontal surface. The cat playground may also comprise a clawing mat or mound portion, a brush mat or mound portion, animal-shaped toy attachments, a tent-like space which may open to reveal a hidden cavity, or a combination of features.

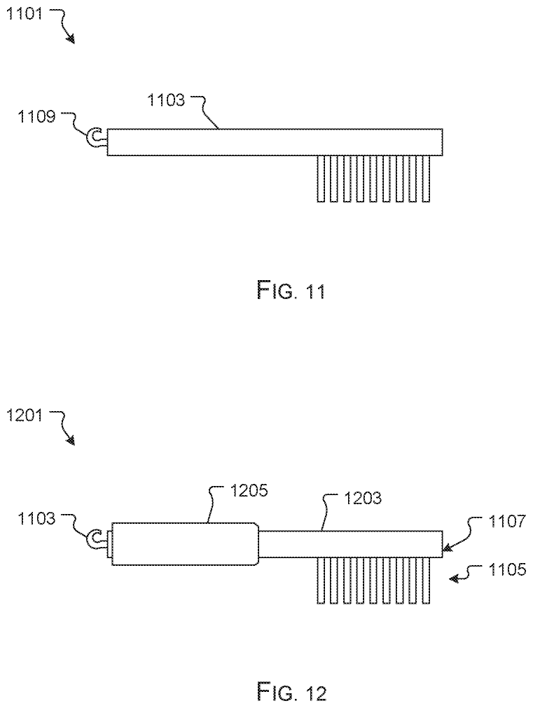

Referring now to FIG. 11, another embodiment 1101 includes a body 1103 that acts as a handle with the bristles 1105 grouped at a far end 1107. In this embodiment, the attachment device 1109 is depicted as a hook so that the embodiment 1101 could be used by the hand or while suspended from the hook.

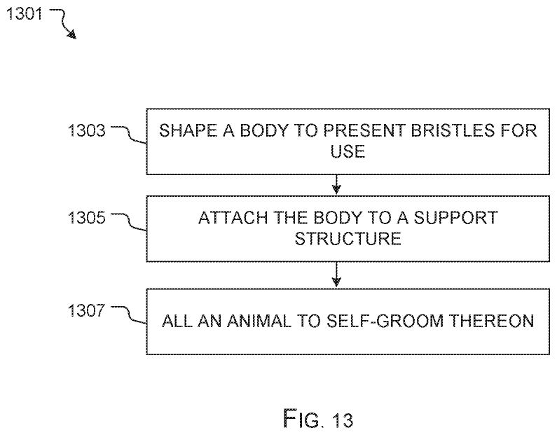

It will be understood and appreciated that a motive device 1205 could be included as depicted by FIG. 12 in embodiment 1201 to automate the motion of the brush or to provide vibration thereof via a body 1203. It will be understood that while intended for use with animals the use of people is also contemplated.

Referring now to FIG. 13 a method of providing self-grooming to an animal is depicted. Method 1301 includes shaping a body to present bristles for use 1303, attaching the body to a support structure 1305 and allowing an animal such as a cat to self-groom, entertain or the like thereon 1307.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A pet entertainment and grooming system, comprising;
at least one body configures to hold a plurality of bristles; and
at least one attachment device;
wherein the body is attached to a support structure via the attachment device; and
wherein the bristles, body or a combination thereof allow an animal to self-groom.

2. The system of claim 1 wherein a motive device is attached thereto and provides motion or vibration to the body or bristles.

3. The system of claim 1 wherein the animal is a person.

4. A pet entertainment and grooming system, comprising;
at least one body configures to hold a plurality of bristles;
wherein the body is free to move about; and
wherein the bristles, body or a combination thereof allow an animal to self-groom.

5. The system of claim 4 wherein the body is configured to move about automatically by a motive force.

6. The system of claim 4 wherein the animal is a person.

7. A method of providing self-grooming or entertainment to an animal, comprising:
shaping a body to present bristles for use;
attaching the body to a support structure; and
allowing an animal such as a cat to self-groom, entertain or the like thereon.
